(19) United States
(12) Patent Application Publication
(10) Pub. No.: US 2007/0287018 A1
(43) Pub. Date: Dec. 13, 2007

(54) Fibrous mats having reduced formaldehyde emissions

(75) Inventors: Kim Tutin, East Point, GA (US); Ramji Srinivasan, Alpharetta, GA (US); Natasha Wright, Stone Mountain, GA (US); Peter Boyer, Conyers, GA (US)

Correspondence Address: PATENT GROUP GA30-43;GEORGIA-PACIFIC LLC, 133 PEACHTREE STREET, NE, ATLANTA, GA, 30303, US

(73) Assignee: Georgia-Pacific Resins, Inc., Atlanta, GA (US)

(21) Appl. No.: 11/450,488

(22) Filed: Jun. 9, 2006

(51) Int. Cl. B32B 17/02; B32B 27/08; B05D 1/12; B05D 7/00

(52) U.S. Cl. 428/505; 442/172; 442/180; 427/421.1; 427/180

(57) ABSTRACT

A process for making a fibrous product using a binder based on a formaldehyde-containing resin and especially for making fiberglass insulation, and to the fibrous product itself, wherein a formaldehyde scavenger is separately applied to the fibrous mat, such as by treating the fibers with an aqueous mixture consisting essentially of the formaldehyde scavenger, with the result that the fibrous product exhibits a reduced level of formaldehyde emissions.

### FIELD OF THE INVENTION

The present invention relates to a process for making fibrous mats using formaldehyde-containing resins and especially for making fiberglass insulation, and to the fibrous mat products themselves, which exhibit a reduced level of formaldehyde emissions.

### BACKGROUND OF THE INVENTION

Phenol-formaldehyde (PF) resins, as well as PF resins extended with urea (PFU resins), have been the mainstays of fiberglass insulation binder technology over the past several years. Such resins are inexpensive and provide the cured fiberglass insulation product with excellent physical properties.

Generally, fiberglass insulation is shipped in a compressed form to facilitate its transportation and reduce costs. When the compressed bundles of fiberglass are used at a job site, it is important that the compressed fiberglass product recover a substantially amount of it pre-compressed thickness. If not, the product will suffer a decrease is its thermal insulation and sound attenuation properties. Fiberglass insulation made with PF and PFU resins is able to recover most of its pre-compressed thickness, thus contributing to the wide acceptance of these resins in this application.

One of the drawbacks of this technology, however, is the potential for formaldehyde emissions during the preparation of the adhesive resin, during the manufacturing of the fiberglass insulation, and during subsequent use of the insulation.

Fiberglass insulation is typically made by spraying a dilute aqueous solution of the PF or PFU resin adhesive binder onto glass fibers, generally hot from being recently formed, forming a mat or blanket of the resin-treated fibers and then heating the mat or blanket to an elevated temperature in an oven to complete the cure of the adhesive resin binder.

Manufacturing facilities using PF and PFU resins as the main adhesive binder component for insulation products recently have invested in pollution abatement equipment to minimize the possible exposure of workers to formaldehyde emissions and to meet Maximum Achievable Control Technology (MACT) requirement Standards during the manufacturing of the fiberglass insulation.

Reducing formaldehyde emissions in the manufacturing environment, however, does not necessarily reduce subsequent formaldehyde emissions from the resulting insulation product. Producing a product having a reduced tendency to emit formaldehyde remains a goal of manufacturers producing products bonded with formaldehyde-containing resins.

As an alternative to PF and PFU resins, certain formaldehyde free formulations have been developed for use as an adhesive binder for making fiberglass insulation products. While such technology potentially holds the promise of lowered formaldehyde emission from the ultimate product, unfortunately, implementation of the commercial technology that is currently available is considerably more expensive, in terms of both raw material cost and equipment upgrades, relative to the PF and PFU resins that have been the mainstay of the fiberglass insulation industry.

Thus, there is a continuing need for new methods for making glass fiber products such as fiberglass insulation using formaldehyde-containing resin binders that produce products having a reduced tendency to emit formaldehyde.

### BRIEF DESCRIPTION OF THE DRAWINGS

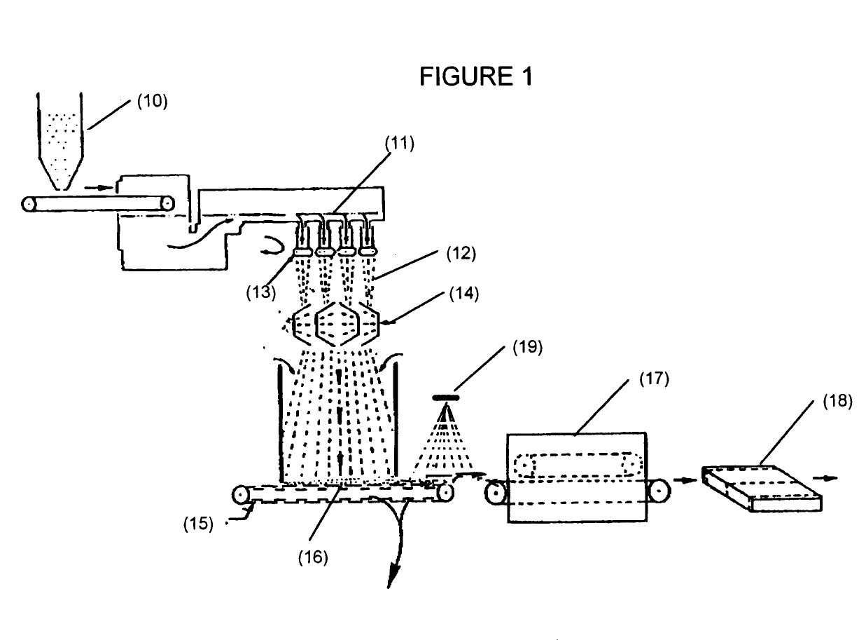

The sole FIGURE (FIG. 1) schematically illustrates one embodiment of a method of making fiberglass insulation having a reduced tendency to emit formaldehyde in accordance with the present invention.

### DETAILED DESCRIPTION OF THE INVENTION

The present invention is directed to a method for making a fibrous mat, such as for making fiberglass insulation, using a formaldehyde-containing resin binder, which results in a product having a reduced tendency to emit formaldehyde. The invention also is directed to the resulting products that have a reduced tendency to emit formaldehyde, such as fiberglass insulation products, made with cured (crosslinked) formaldehyde-containing resin binders.

As used herein, the phrase “formaldehyde-containing resin” means a resinous, thermosetting composition made from a molar excess of formaldehyde and one or more formaldehyde-reactive monomers such as phenol, urea, acetone, melamine and the like. Such resins typically contain free, i.e., unreacted formaldehyde, and exhibit formaldehyde emissions during their cure and in the absence of an effective treatment, following their cure. Such resins are well known to those skilled in the art and do not require a detailed description. Such resins are commercially available from resin suppliers such as Georgia-Pacific Resins, Inc.

A formaldehyde-containing resin commonly used in connection with the manufacture of fiberglass insulation is one made by reacting a molar excess of formaldehyde with phenol in the presence of an alkaline catalyst such as sodium hydroxide. Before this resin is used, it is commonly premixed with urea and the urea is allowed to react with residual formaldehyde, such as for 4-16 hours, before the binder is prepared for making the fiberglass insulation.

As used herein, “curing,” “cured” and similar terms are intended to embrace the structural and/or morphological change which occurs to an aqueous binder of a formaldehyde-containing resin, such as, for example, by covalent chemical reaction (crosslinking), ionic interaction or clustering, improved adhesion to the substrate, phase transformation or inversion, and hydrogen bonding when the resin is dried and heated to cause the properties of a flexible, porous substrate, such as a mat or blanket of glass fibers to which an effective amount of the binder has been applied, to be altered.

The term “cured binder” means the cured formaldehyde-containing resin which bonds the fibers of a fibrous product together. Generally, the bonding occurs at the intersection of overlapping fibers.

By “reduced tendency to emit formaldehyde” and related phrases are meant that a product, such as a fibrous mat made in accordance with the method of the present invention, exhibits a lower level of formaldehyde emission than the product would have exhibited if made with the same binder but in the absence of the formaldehyde scavenging technique, such as the method of the present invention.

As used herein, “aqueous” means water and mixtures composed substantially of water.

As used herein the terms “fiber,” “fibrous” and the like are intended to embrace materials that have an elongated morphology exhibiting an aspect ratio (length to thickness) of greater than 100, generally greater than 500, and often greater than 1000.

As used herein the terms “heat resistant fibers” and the like are intended to embrace fibers suitable for withstanding elevated temperatures such as mineral fibers, aramid fibers, ceramic fibers, metal fibers, carbon fibers, polyimide fibers, certain polyester fibers, rayon fibers, and especially glass fibers. Such fibers are substantially unaffected by exposure to temperatures above about 120° C.

As used throughout the specification and claims, the terms “mat,” “batt” and “blanket” are used somewhat interchangeably to embrace a variety of fibrous substrates of a range of thicknesses and densities, made by entangling short fibers, long continuous fibers and mixtures thereof. Particularly preferred are mats, batts, or blankets made using heat resistant fibers.

In a first aspect, the present invention is directed to a method for making a fibrous mat that exhibits a reduced tendency to emit formaldehyde, wherein the fibrous mat is prepared using an aqueous binder composition comprising a formaldehyde-containing resin. A key feature of the method is the application of a formaldehyde scavenger, usually applied as an aqueous mixture consisting essentially of the formaldehyde scavenger, to the fibers of the mat. By requiring that the aqueous mixture consist essentially of a formaldehyde scavenger, this aqueous mixture is applied to the fibers separate from the application of any formaldehyde-containing resin binder.

In another aspect, the present invention provides a method for binding together a loosely associated, non-woven mat or blanket of heat resistant (e.g., glass) fibers comprising (1) contacting hot fibers with a curable, aqueous binder composition comprising a formaldehyde-containing resin, (2) heating said curable binder composition to an elevated temperature, which temperature is sufficient to effect cure of the formaldehyde-containing resin and (3) applying a formaldehyde scavenger to the fibrous mat. Usually an aqueous mixture consisting essentially of a formaldehyde scavenger is applied on to the fibers.

Again, by requiring that the aqueous mixture consist essentially of a formaldehyde scavenger, the aqueous mixture is applied to the fibers separate from the application of the formaldehyde-containing resin binder to the fibers. Preferably, curing of the formaldehyde-containing resin is effected at a temperature broadly within the range from 75° C. to 300° C. usually at a temperature between 100° C. and less than about 250° C.

In yet another aspect, the present invention provides a fibrous product, especially a fiberglass insulation product, exhibiting a reduced tendency to emit formaldehyde, having fibers bonded to one another with a crosslinked (cured) binder obtained by curing a curable binder comprising a formaldehyde-containing resin, the fibers being in close proximity to a formaldehyde scavenger which is separate from the cured binder, such as when fibers are at least partially coated with a layer consisting essentially of a formaldehyde scavenger, the formaldehyde scavenger being present in an amount sufficient to reduce formaldehyde emissions from the fiber product.

The invention will now be described with reference to FIG. 1, which schematically illustrates one process for making fiberglass insulation. While the invention is illustrated in connection with this specific embodiment, those skilled in the art will appreciate that the invention can be adapted for use in reducing the tendency of a fibrous product to emit formaldehyde in connection with the manufacture of a wide variety of other fibrous products that use a formaldehyde-containing resin binder and that the invention also can be practiced using a variety of other techniques for placing the formaldehyde scavenger in close proximity to but separate from the cured formaldehyde-containing resin binder.

As illustrated schematically in FIG. 1, the manufacture of fiberglass insulation can be accomplished using continuous processes wherein molten glass flows from a melting furnace (10) is divided into streams (11) and is attenuated into fibers (12). The fiber attenuation generally is performed by centrifuging the molten glass though spinners (13) or by fluid jets (not shown) to form discontinuous glass fibers (12) of relatively small dimensions.

A curable binder composition is generally formulated as a liquid and is applied usually by spraying (14) or fogging onto the hot glass fibers emerging from the fiber attenuation mechanism. The resin-treated fibers then are collected as they are randomly deposited on a moving foraminous conveyor belt (15). The dynamics of the binder application is such that much of the water in the binder is evaporated as the hot fibers are cooled by contact with the aqueous binder. The resin binder then becomes tacky holding the mass of fibers together as the resin begins to set. The fibers are collected on a conveyor belt (15) in a generally haphazard manner to form a non-woven mat (16). The depth (thickness) of the fibers forming the mat is determined by the speed of fiber formation and the speed of the conveyor belt (15). The fibrous product can be formed as a relatively thin product of about ⅛ to ¼ inch or it can be formed as a thick mat of 6 to 8 inches or even more. Depending on formation conditions, the density of the product also can be varied from a relatively fluffy low density product to a higher density of 6 to 10 pounds per cubic foot or higher, as is well understood by those skilled in the art.

In fiberglass insulation products, heat resistant fibers generally are bonded together into an integral structure with an aqueous curable binder, typically an aqueous formaldehyde-containing resin. One particularly common resin within the group of formaldehyde-containing resins is the heat curable, i.e., thermosetting, resin systems of the phenol-formaldehyde (PF) type. Included within this group also are PF resins that have been modified by the addition of urea (PFU resins). These resins are typically synthesized in an aqueous reaction medium under alkaline reactions conditions, generally established using an alkali metal hydroxide and especially sodium hydroxide. In making these resins, phenol is reacted with a molar excess of formaldehyde, normally to a very low level of residual phenol. In the case of PFU resins, an amount of urea basically in an amount sufficient to react with the residual formaldehyde is subsequently added and is reacted, typically for about 4 to 16 hours.

Another common class of formaldehyde-containing resins often used in making thin fiber products is the thermosetting urea-formaldehyde (UF) resins. UF resins also are reacted (produced) under alkaline conditions. UF resins used in binder formulations for making fiber products, such as air filters which may be about one inch thick, also are commonly cured under acid conditions using a latent acid catalyst such as triethylamine sulfate.

Such binders provide a strong bond between fibers with sufficient elasticity and thickness recovery to permit reasonable shipping and in-service deformation of the fibrous products, such as fiberglass insulation.

Such formaldehyde-containing binders are generally provided as water soluble or water dispersable compositions which can be easily blended with other ingredients (such as ammonium sulfate which is used as a cure accelerator or catalyst) and diluted to low concentrations which are readily sprayed (14) or fogged onto the hot fibers as they drop onto the collecting conveyor belt (15). Generally an amount of binder is applied sufficient to fix the position of each fiber in the mat by bonding fibers where they cross or overlap. Using binders with good flow characteristics allows the binder to flow to these fiber intersections. Thus, the binder composition is generally applied in an amount such that the cured binder constitutes about 1% to about 20% by weight, more usually about 3 to 12% by weight of the finished fibrous product. The level of binder usage is not a limiting feature of the present invention.

Usually, the aqueous formaldehyde-containing binder for making fiberglass insulation is prepared by diluting with additional water a formaldehyde-containing resin from a higher solids content to an aqueous mixture of a relatively low solids concentration of on the order of 3 to 40% by weight solids for applying, such as by spraying or fogging, onto the hot fibers. The actual solids content of the binder is not a limiting feature of the present invention.

The glass fiber mat (16) then may be compressed and shaped into its desired thickness as it is passed through a curing oven (17) where the binder is cured, thus fixing the size and shape of the finished insulating product by bonding the mass of fibers one to another to form an integral composite structure (18). In addition to radiant curing ovens, radio frequency and microwave heaters can also be mentioned. The present invention is not to be limited to any particular way for causing an adequate cure of the formaldehyde-containing resin.

As noted above, in the making of fibrous products, such as fiberglass insulation, the binder composition is formulated into a dilute aqueous solution and then is usually applied, such as by spraying, onto the fibers. Binder compositions containing somewhere between 3% by weight and 40% by weight solids are typically used for making fiber products, including fiberglass insulation.

The aqueous binder can be easily blended with other ingredients commonly used in binder compositions for preparing fiber products, such as heat resistant fibrous products, and the binder can be diluted to a low concentration which is readily applied onto the fibers, such as by spraying or fogging.

For example, to prepare a binder composition, it may be advantageous to add a silane coupling agent (e.g., an organo silicon oil) to the binder mixture in an amount of at least about 0.02 wt. % based on the weight of binder solids. Suitable silane coupling agents (organo silicon oils and fluids) have been marketed by the Dow-Corning Corporation, Petrarch Systems, and by the General Electric Company. Their formulation and manufacture are well known such that detailed description thereof need not be given. This invention is not directed to and thus is not limited to the use of any particular silane additives.

Fibrous mat manufacturers also normally add “dedusting” oil to minimize dust formation in the finished product. Such dedusting oils are usually high boiling point mineral oils. Ammonia and ammonium sulfate (a cure accelerator or latent acid catalyst) also are commonly added. Owens-Coming also adds dye to the binder formulation to color the product pink. Other pigments, such as carbon black, also may be added. This invention is not directed to and thus is not limited to the use of any such additives or pigments.

The binder composition may be prepared by combining the aqueous formaldehyde-containing resin binder and the silane coupling agent, dedusting oil, ammonium sulfate, dyes, pigments and other optional ingredients in a relatively easy mixing procedure carried out at ambient temperatures. The binder composition can be used immediately and may be diluted with water to a concentration suitable for the desired method of application, such as by spraying or fogging onto the fibers.

As recognized by those skilled in the art and depending to some extent on the nature of the fiber product being produced, both the formaldehyde-containing resin binder and the aqueous mixture consisting essentially of the formaldehyde scavenger may be applied to the fibers by one of a variety conventional techniques such as, for example, air or airless spraying, padding, saturating, roll coating, curtain coating and the like. For example, when making thin mats of glass fibers, such as those used in making roofing shingles or those used as air filtration mats, the binder composition and the aqueous mixture consisting essentially of the formaldehyde scavenger can be applied separately to the glass fibers by flooding the collected mat of fibers and draining off the excess, by spraying the fiber mat or the like. The present invention is not to be limited to the specific way in which the binder and the formaldehyde scavenger are separately applied onto the fibers.

Continuous fibers also may be employed in the form of mats or blankets fabricated by swirling the endless filaments or strands of continuous fibers, or they may be chopped or cut to shorter lengths for mat, batt or blanket formation. Use can also be made of ultra-fine fibers formed by the attenuation of glass rods. Also, such fibers may be treated with a size, anchoring agent or other modifying agent before use in making the fibrous mat or blanket.

Heat resistant fiber products, including glass fiber insulation products, may also contain fibers that are not in themselves heat-resistant such as, for example, certain polyester fibers, rayon fibers, nylon fibers, cellulose fibers and super absorbent fibers, in so far as they do not materially adversely affect the performance of the fibrous product.

The aqueous binder composition, after it is applied to the glass fibers, is heated to effect drying and curing. In the embodiment illustrated in FIG. 1, after the initial portion of this heating (primarily drying) which occurs as a result of the transfer of heat from the hot fibers to the aqueous binder applied to the fibers (as the recently formed hot glass fibers are cooled by the aqueous binder), the mat is passed through an oven (17). The duration and temperature of the heating in the oven will affect the rate of drying, processability and handleability, degree of curing and property development of the resulting fibrous mat. The curing temperatures are usually within the range from 50 to 300° C., and preferably within the range from 90 to 230° C. and the curing time will usually be somewhere between 3 seconds to about 15 minutes. Of course, other temperatures and times can be used depending upon particular binder formulations and the present invention is not limited to any specific set of conditions.

On heating, residual water present in the binder composition evaporates, and the composition undergoes curing. These processes can take place in succession or simultaneously. Curing in the present context is to be understood as meaning the chemical alteration of the composition, for example crosslinking through formation to covalent bonds between the various constituents of the composition, the formation of ionic interactions and clusters, and formation of hydrogen bonds.

As noted, the drying and curing functions may be carried out in two or more distinct steps, if desired. For example, the composition may be first heated at a temperature and for a time sufficient to substantially dry but not to substantially cure the binder composition and then heated for a second time at a higher temperature and/or for a longer period of time to effect curing (thermosetting). Such a preliminary “drying” procedure, generally referred to as “B-staging”, may be used to provide binder-treated product, for example, in roll form, which may at a later stage be cured, with or without forming or molding into a particular configuration, concurrent with the curing process. This makes it possible, for example, to produce binder-impregnated semifabricates which can be molded and cured elsewhere.

In accordance with the present invention, separate from the application of the formaldehyde-containing resin binder to the fibers, the fibrous mat also is contacted with a formaldehyde scavenger. In the embodiment of FIG. 1, the fibers of the fibrous mat are contacted with an aqueous mixture consisting essentially of a formaldehyde scavenger. As shown in FIG. 1, an aqueous mixture consisting essentially of a formaldehyde scavenger is sprayed onto the resin-treated fibers following their collection onto the conveyor and prior to their entering into the oven (17) using a sprayer (19). By spraying an aqueous mixture of a formaldehyde scavenger in this manner, the fibers are at least partially coated with a layer of scavenger on at least the upper surface of the fibrous mat facing the sprayer (19).

As used herein, the phrase “consisting essentially of” used in connection with the aqueous mixture of the formaldehyde scavenger is intended to exclude from the aqueous mixture any ingredients that would change the basic formaldehyde-reducing purpose and function of the formaldehyde scavenger that is applied with the aqueous mixture. Thus, this phrase is intended to exclude any ingredient, such as any formaldehyde-containing resin binder, from the aqueous formaldehyde scavenger mixture that would increase the formaldehyde burden of the fibrous mat. Preferably, the aqueous mixture contains only, i.e., consists of, the formaldehyde scavenger and the complement water.

Suitable formaldehyde scavengers for use in the present invention, such as for preparing the aqueous mixture of the formaldehyde scavenger include singly or in combination such materials as urea ((H₂N)₂C═O), low ratio melamine resins, i.e., melamine-formaldehyde resins made with a molar excess of melamine, sodium bisulfite, sodium metabisulfite, other alkali metal and alkaline earth metal bisulfites, ammonium bisulfate, resorcinol, polyacrylamide, acrylamide, methacrylamide, melamine, biuret (HN[(H₂N)C═O]₂), triuret (N[(H₂N)C═O]₃), biurea ([HN(H₂N)C═O]₂), polyurea, acid salts of aniline, aromatic amines, aliphatic amines, diethylene triamine, triethylene tetraamine, tetraethylene pentamine and their salts, ammonia, polyamidoamines, amino acids, aromatic amino acids such as glycine, p-amino benzoic acid, ammonium bicarbonate, ammonium carbonate, polyethyleneamines, sodium sulfamate, ammonium sulfamate, polyamines, methane sulfonamide, succinimide, dicyandiamide (NCNH(H₂N)C═NH), sulfur compounds with valence state other than +6, ammonium sulfite, proteins (for example: soy, animal and plant proteins), an aminopolysaccharide, such as chitosan, thiourea ((H₂N)₂C═S), guanadine((H₂N)₂C═NH), sodium salts of taurine, sulfanilic acid, disodium salt of glutamic acid, zeolites and permanganate.

Depending on the particular embodiment, certain scavengers will likely exhibit more effective treatment. Optimal selection of a particular scavenger can generally be accomplished using routine experimentation. Particularly preferred formaldehyde scavengers are urea, low mole ratio melamine-formaldehyde resins and sodium metabisulfite (and the related material sodium bisulfite).

An aqueous mixture of a formaldehyde scavenger (or formaldehyde scavengers) is prepared simply by mixing the scavenger (or scavengers) with water. The concentration of formaldehyde scavenger in the aqueous mixture can vary within wide limits (and is usually influenced by the aqueous solubility or miscibility of the scavenger), provided the amount does not interfere with the technique chosen for applying the aqueous mixture to the fibers, generally accomplished by spraying. Usually, the aqueous mixture contains from as little as 0.01% by weight to as much 60% by weight or more of the formaldehyde scavenger, depending in many cases on the aqueous solubility or miscibility of the particular scavenger. The present invention is not limited to any specific level of scavenger in a aqueous scavenger mixture.

The formaldehyde scavenger is applied to the fibrous mat, such as by applying an aqueous mixture consisting essentially of a formaldehyde scavenger onto the fibers used to prepare the mat, so as to provide a sufficient amount of scavenger in the fibrous mat to reduce the tendency of the cured product to emit formaldehyde. Applicants have observed emissions can be reduced to non-detectable levels using generally accepted analytical detection techniques. Usually, a sufficient amount of formaldehyde scavenger, such as the aqueous mixture, is applied to provide the scavenger in an amount of from 1 to 200% by weight or more of the curable formaldehyde-containing resin binder solids in the fibrous mat, usually in an amount of from 10 to 100% by weight and most often in an amount of from 10 to 70% by weight of the curable formaldehyde-containing resin binder solids.

A key advantage of the present invention is that because the application of the formaldehyde scavenger is independent of and not intimately commingled with the formaldehyde-containing resin binder, the addition of higher levels of the scavenger does not significantly degrade the tensile properties of the cure binder essential for obtaining a fibrous mat with acceptable physical properties. As shown in the following examples, including the scavenger directly in the binder formulation (internal scavenger), not only fails to adequately reduce the tendency of the cured product to emit formaldehyde but also disadvantageously reduces the tensile properties of the cured product.

While not wishing to be bound by any particular theory, it is believed that the present invention maximizes the effectiveness of the scavenger for complexing with formaldehyde by applying the formaldehyde scavenger to the fibrous mat separately or independently from the formaldehyde-containing binder. For example, in the case of a sodium metabisulfite scavenger it is believed that the addition of this material into the binder formulation, which for processing and performance reasons is maintained at an alkaline pH, causes most of the scavenger to be converted to sodium sulfite. Applicants have observed that sodium sulfite is a much less effective scavenger than the bisulfite. By maintaining the sodium metabisulfite separate from the alkaline formaldehyde-containing resin binder when applying the scavenger to the fibrous mat, this conversion is significantly retarded. In the case of internal scavengers, it is also believed that they are less successful than the present invention because formaldehyde that might otherwise be consumed in polymerization reactions participates in reactions with scavenger, thus depleting the amount of scavenger available for reducing formaldehyde emissions from the product. As shown in the following examples, simply adding more internal scavenger to the binder is not a solution because this approach degrades the properties of the product.

While the present invention has been illustrated using an embodiment in which the formaldehyde scavenger is sprayed onto resin-treated fibers via an asqueous mixture after the fibers have been collected onto the conveyor transporting the fibrous mat into the curing oven, it should be understood that the present invention is not to be limited to this application method only. Thus, the present invention is open both (1) to other techniques for applying the formaldehyde scavenger to the fibers and to the fibrous mat, such as by applying an aqueous mixture consisting essentially of a formaldehyde scavenger by curtain coating, by roll coating, by dipping and the like or by applying a scavenger in a neat form, that is free from admixture or dilution in an aqueous mixture, to the fibrous mat and (2) to the application of the formaldehyde scavenger at other locations in the manufacture of fibrous mats, such as coincident with fiber formation or after the cured mat has emerged from the curing oven and up to the point that the product may be packaged for distribution. The key feature of all such application methods, however, is that the scavenger is applied to the fiber and fibrous mat separate from the formaldehyde-containing binder in a way to reduce and preferably prevent intermingling or intermixing with the uncured binder.

Thus, in some cases the formaldehyde scavenger may be a solid or the solid can be melted to produce a molten liquid and the present invention contemplates applying such neat forms of the formaldehyde scavenger to the fibrous mat separate from application of the formaldehyde-containing resin binder to the fibers. In the case of a molten liquid, the scavenger can be sprayed or dripped on to the fibers, in the case of a solid form of the scavenger, the scavenger preferably is applied as small particles that can be retained within the porosity of the mat. Particles that pass through a 3 Mesh screen (Tyler Screen designation) but are retained by a 100 mesh screen should be suitable. The particles can be sprinkled onto the mat as the resin-fibers are collected or after the resin has emerged from the curing oven. In the latter case, vibration of the fibrous mat could be used to facilitate penetration of the particles into and retention of the particles by the fibrous mat. Alternatively, the scavenger could be loaded onto an inert carrier material, such as by coating or absorbing the scavenger, for example using an aqueous solution, onto sepiolite, activated carbon, activated carbon fibers, zeolite, activated alumina, vermiculite, diatomaceous earth, perlite particles or cellulose fibers, with the scavenger-loaded inert material then being added to the fiber mat.

There is some indication that the performance of the formaldehyde scavenger applied in accordance with the present invention may be improved by the presence of a moisturizer. The moisturizer could be the humidity available in the ambient environment, a polyol such as glycerol, polyamines, trimethylol propane, amine salts, calcium chloride, deliquescent materials, polyacrylamide, super absorbent gells, starch, or any liquid. In cases where the scavenger is applied as an aqueous solution and dried, applicants suspect that residual moisture in the dried scavenger coating may assist the formaldehyde reducing performance of the scavenger.

Applicants have also observed that when using sodium bisulfite as a scavenger for fiberglass insulation made with PFU resin binder that the presence of the sodium bisulfite scavenger has an ameliorating effect on color development observed in the mat. In particular, mats having a cured PFU resin binder typically develop what can be characterized as a dark or dingy yellow color. When such mats are treated with a sodium bisulfite scavenger, the yellow color becomes lighter or more muted as the level of treatment increases. One benefit of this effect is that the lighter yellow color makes the product esthetically more pleasing to the end consumer. Alternately, it may become easier to color the mat a different color (such as pink or blue) by supplying a dye or pigment as part of the manufacturing process. Less treatment may be needed to color the more lightly colored mats obtained following sodium bisulfite scavenger treatment.

When making glass fiber products, such as fiberglass insulation, usually 99-60 percent by weight of the product will be composed of glass fibers or other heat resistant fibers, while the amount of binder solids will broadly be in reverse proportion ranging from 1-40 percent, depending upon the density and character of the product. Glass insulations having a density less than one pound per cubic foot may be formed with binders present in the lower range of concentrations while molded or compressed products having a density as high as 30-40 pounds per cubic foot can be fabricated of systems embodying the binder composition in the higher proportion of the described range.

Glass fiber products can be formed as a relatively thin product, such as a mat having a thickness of about 10 to 50 mils; or they can be formed as a relatively thick product, such as a blanket of 12 to 14 inches or more. The time and temperature for cure for any particular fiber product will depend in part on the amount of binder in the final structure and the thickness and density of the structure that is formed and can be determined by one skilled in the art using only routine testing. For a structure having a thickness ranging from 10 mils to 1.5 inch, a cure time ranging from several seconds to 1-5 minutes usually will be sufficient at a cure temperature within the range of 175°-300° C. Other temperatures and times can also be used as being within the skill of the art.

Treatment of this full range of fibrous products is contemplated by using a formaldehyde scavenger in either a neat form or as an aqueous mixture consisting essentially of a formaldehyde scavenger.

Fibrous products made in accordance with the present invention may be used for applications such as, for example, insulation batts, rolls, molded parts, as reinforcing mat for roofing, flooring, or gypsum applications, as air filters, as roving, as microglass-based substrate for printed circuit boards or battery separators, as filter stock, as tape stock, and as reinforcement scrim in cementitious and non-cementitious coatings for masonry.

It will be understood that while the invention has been described in conjunction with specific embodiments thereof, the foregoing description and following examples are intended to illustrate, but not limit the scope of the invention. Other aspects, advantages and modifications will be apparent to those skilled in the art to which the invention pertains, and these aspects and modifications are within the scope of the invention. For example, the techniques of the present invention can readily be adapted, as those skilled in the art immediately appreciate from the prior description, to use in manufacturing other fibrous product such as pipe insulation designed to envelop pipe used for conveying high temperature fluids.

### EXAMPLE 1

To simulate the manufacture of fiberglass insulation, batts were prepared in the laboratory as follows. A roll of 1 inch thick, un-bonded, fiberglass was obtained from Resolute Manufacturing and divided into individual sheets weighing about 30 grams. Individual un-bonded fiberglass sheets were placed in a tray. A formaldehyde-containing binder was placed into a reservoir and air was used to aspirate the binder into a fine mist. The mist was drawn through each individual batt using an air exhaust hood. This technique caused fine binder droplets to be deposited onto and into the batt. In each experiment, approximately eight grams of binder was deposited onto each sample of the glass batt. In the case of those experiments simulating the present invention, after misting with the binder, a surface of the batt was sprayed with an aqueous formaldehyde scavenger solution using a Windex®-type spray bottle. In either case, following binder application, the batt was next cured in a forced air oven for two minutes at 425° F. (218° C.) to cure the binder. After curing, the batt was transferred to a Ziplock®-type storage bag until the sample could be tested using a consistent technique in a dynamic micro chamber (DMC) to test its formaldehyde emission characteristic. A DMC is described in Georgia-Pacific Resins, Inc. U.S. Pat. Nos. 5,286,363 and 5,395,494.

Two batt samples were prepared (two replicates) for each of the experiments and testing examined five different treatment scenarios. In all cases, the binder was formulated from an aqueous phenol-formaldehyde resin that is commercially available from Georgia-Pacific Resins, Inc. as resin 209G47. The aqueous resin was mixed with a 40% by weight aqueous solution of urea in an amount of 1 part urea solution per approximately 7 parts aqueous resin. The mixture was allowed to “pre-react” overnight at room temperature before the binder was applied to the batts. Shortly before application to the batts, 1 part by weight of an aqueous ammonium sulfate solution (20% by weight ammonium sulfate), as a cure accelerator or catalyst, was added per approximately 2 parts by weight of the binder to complete the base binder formulation.

In the Control experiment, only the above-formulated binder was applied to the fiberglass batt. In a Comparative experiment, a formaldehyde scavenger (sodium bisulfite) also was added to the above-formulated binder and was dissolved in the binder shortly before the binder was applied to the batts. The scavenger was added to the binder in an amount of 1 part scavenger (sodium bisulfite) per approximately 17.6 parts of the aqueous resin used in the binder (this corresponds to 1 part scavenger per approximately 9 parts phenol-formaldehyde resin solids). In the experiments illustrating the present invention, subsequent to the application of the base binder formulation to the batts (but prior to placing the batts in the curing oven), an aqueous sodium bisulfite solution (20% by weight sodium bisulfite) in an amount of 1 gram per batt sample (Experiment A); an aqueous urea solution (20% by weight urea) in an amount of 1 gram per batt sample (Experiment B) and an aqueous low mole ratio melamine-formaldehyde (MF) resin solution (20% by weight MF resin) in an amount of 1 gram per batt sample (Experiment C), was separately applied to the batts by spray bottle.

The raw results of each of the two replicates obtained from the DMC testing for each experiment, the average results and the levels of reduction in formaldehyde emission are reported in Table 1 below. As shown, the method of the present invention resulted in a significant reduction in formaldehyde emission compared with both the Control Example and the Comparative Example.

TABLE 1
Formaldehyde Emission Results
(ppm Formaldehyde)

| EXPERIMENT | Control | Comparative | A | B | C |
|---|---|---|---|---|---|
| Replicate 1 | 0.190 | 0.174 | 0.136 | 0.130 | 0.101 |
| Replicate 2 | 0.182 | 0.168 | 0.112 | 0.128 | 0.125 |
| Average | 0.186 | 0.171 | 0.132 | 0.129 | 0.113 |
| % Reduction | — | 8.1 | 29.0 | 30.6 | 39.2 |
| from Control | | | | | |

### COMPARATIVE EXAMPLE 2

The tensile strengths (dry and hot/wet) of glass mat hand sheets bonded using a typical phenol-formaldehyde resin binder was compared to hand sheets prepared with binders having sodium bisulfite, as a formaldehyde scavenger, added to the resin to assess the impact on tensile properties of an internal scavenger.

Binders were formulated from an aqueous phenol-formaldehyde resin that is commercially available from Georgia-Pacific Resins, Inc. as resin 209G56. The aqueous resin first was mixed with a 40% by weight aqueous solution of urea in an amount of 1 part urea solution per approximately 1.8 parts aqueous resin. The mixture was allowed to “pre-react” overnight at room temperature to yield a pre-mix. Shortly before application to a glass mat, 1 part by weight of aqueous ammonia (28% by weight ammonia); and 5 parts by weight of an aqueous ammonium sulfate solution (20% by weight ammonium sulfate), as a cure accelerator or catalyst, were added per approximately 38 parts by weight of the pre-mix to complete the base binder formulation.

In addition to testing the tensile properties of the base binder formulation (designated the Control), two binder formulations also were prepared for testing one having an additonal 5% by weight of sodium bisulfite added as a formaldehyde scavenger (designated Comparative A) and the other having an additional 50% by weight of sodium bisulfite added (designated Comparative B), both as a percentage of binder solids (defined as resin solids plus urea solids).

Various amounts of water were added to these binder formulations to yield a binder with the same amount of total binder solids (20% solids as resin and urea solids). In particular, 1.78 parts water per part of premix was added to the Control, 1.76 parts water per part premix was added to complete the binder of Comparative A, and 1.55 parts water per part premix was added to complete the binder of Comparative B.

Hand sheets were prepared by soaking the mats in the formulated binders and vacuuming excess resin binder off the mat. Following application of the various binders, each sample was cured in a forced air oven for two minutes at 401° F. (205° C.) to cure the binders.

Tensile strengths (dry and hot/wet) of hand sheets prepared using the various techniques (Control, Comparative A, and Comparative B) were determined. Dry tensile strengths of the mats were measured by subjecting samples of each hand sheet to breaking in a tensile tester (QC-1000 Materials Tester by the Thwing Albert Instrument Co.). Hot/Wet tensile strengths of the mats were measured by initially soaking the hand sheets in 185° F. (85° C.) water for 10 minutes followed by breaking them in a tensile tester (QC-1000 Materials Tester by the Thwing Albert Instrument Co.) while the samples were still hot and wet. Fourteen (14) breaks for each sample were measured and the average of the breaking strengths was determined.

The testing results are presented in Table 2. As shown, by using an internal scavenger, in the manner of Comparative A and Comparative B, increasing the level of added scavenger results in a degradation in tensile strength as compared to the Control Example.

TABLE 2
Hand Sheet Tensile Test Results
(lbs tensile strength)

| EXPERIMENT | Control | Comparative A | Comparative B |
|---|---|---|---|
| Ave. Dry Tensile | 59.24 | 55.18 | 41.76 |
| Ave. Hot/Wet Tensile | 39.68 | 40.28 | 22.85 |

### EXAMPLE 3

As in Comparative Example 2, binders were formulated from an aqueous phenol-formaldehyde resin that is commercially available from Georgia-Pacific Resins, Inc. as resin 209G56. The aqueous resin first was mixed with a 40% by weight aqueous solution of urea in an amount of 1 part urea solution per approximately 1.8 parts aqueous resin. The mixture was allowed to “pre-react” overnight at room temperature to yield a pre-mix. Shortly before application to a glass mat, 1 part by weight of aqueous ammonia (28% by weight ammonia); and 5 parts by weight of an aqueous ammonium sulfate solution (20% by weight ammonium sulfate), as a cure accelerator or catalyst, were added per approximately 38 parts by weight of the pre-mix to complete the base binder formulation.

As in Comparative Example 2, an amount of water was added to the binder formulation to yield a binder with 20% binder solids (20% solids as resin and urea solids). In particular, 1.78 parts water per part of premix was added to the binder.

Hand sheets were prepared by soaking the mats in the formulated binder and vacuuming excess resin binder off the mat. Following application of the binder, the sample was cured in a forced air oven for two minutes at 401° F. (205° C.) to cure the binder.

In addition to the Control, a sample was prepared in order to illustrate the present invention, wherein subsequent to the application of the base binder formulation to the mat, but prior to placing the mat in a curing oven, an aqueous sodium bisulfite solution, in an amount to provide 50% by weight of sodium bisulfite solids as a percentage of binder solids, was sprayed onto a surface of the mat using a Windex®-type spray bottle. The binder formulation used in preparing this sample was the same as the Control.

Tensile strengths (dry and hot/wet) of hand sheets prepared using the various techniques (Control and The Invention) were determined. Dry tensile strengths of the mats were measured by subjecting samples of each hand sheet to breaking in a tensile tester (QC-1000 Materials Tester by the Thwing Albert Instrument Co.). Hot/Wet tensile strengths of the mats were measured by initially soaking the hand sheets in 185° F. (85° C.) water for 10 minutes followed by breaking them in a tensile tester (QC-1000 Materials Tester by the Thwing Albert Instrument Co.) while the samples were still hot and wet. Twelve (12) breaks for each inventive sample and six (6) breaks for the Control were measured and the average of the breaking strengths was determined.

The testing results are presented in Table 3. As shown, the method of the present invention avoids the degradation in tensile strength value that accompanies the addition of scavenger directly to the binder (internal scavenger) as compared to the Control Example as illustrated in Comparative Example 2.

TABLE 3
Hand Sheet Tensile Test Results
(lbs tensile strength)

| EXPERIMENT | Control | The Invention |
|---|---|---|
| Ave. Dry Tensile | 46.45 | 48.48 |
| Ave. Hot/Wet Tensile | 39.38 | 40.16 |

The present invention has been described with reference to specific embodiments.

However, this application is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass +or −5%.

I/We claim as follows:

1. In a process of producing a fibrous mat wherein fibers are treated with an aqueous binder comprising a formaldehyde-containing resin, and the resin-treated fibers are collected and passed through an oven to cure the resin, the improvement comprising separately applying a formaldehyde-scavenger to the fibrous mat.

2. The process of claim 1 wherein the formaldehyde scavenger is applied to the fibrous mat by spraying an aqueous mixture consisting essentially of a formaldehyde-scavenger on the fibers.

3. The process of claim 2 wherein the aqueous binder is applied to hot fibers and the aqueous mixture is sprayed on the resin-treated fibers before they are passed through the oven.

4. The process of claim 3 wherein the resin-treated fibers are collected to form a mat and the aqueous mixture consisting essentially of the formaldehyde-scavenger is sprayed on a surface of the mat.

5. The process of claim 2 wherein the aqueous mixture is sprayed on the fibers after the resin has been cured.

6. The process of claim 2 wherein the aqueous mixture is sprayed on the fibers before the fibers are treated with the aqueous binder.

7. The process of claim 1 wherein a neat form of the formaldehyde scavenger is applied to the fibrous mat.

8. The process of claim 7 wherein the neat form of the formaldehyde scavenger is in the form of solid particles.

9. The process of claim 7 wherein the scavenger is loaded onto an inert carrier.

10. The process of claim 1 wherein the formaldehyde scavenger is selected from the group consisting of urea, low ratio melamine resins, sodium bisulfite, sodium metabisulfite, sodium sulfamate, ammonium sulfamate, an acid aniline salt, ammonium bisulfite, methane sulfonamide, succinimide, resorcinol, polyacrylamide, acrylamide, methacrylamide, melamine, diethylene triamine and its salts, triethylene tetraamine and its salts, tetraethylene pentamine and its salts, biuret, triuret, biurea, polyurea, aromatic amines, aliphatic amines, ammonia, polyamidoamines, ammonium bicarbonate, ammonium carbonate, polyethyleneamines, polyamines, dicyandiamide, a sodium salt of taurine, sulfanilic acid, sulfur compounds with valence state other than +6, ammonium sulfite, disodium salt of glutamic acid, an amino acid, a protein, an aromatic amino acid, an aminopolysaccharide, p-amino benzoic acid, thiourea, guanadine, zeolites and permanganate.

11. The process of claim 2 wherein the formaldehyde scavenger is selected from the group consisting of urea, low ratio melamine resins, sodium bisulfite, and sodium metabisulfite.

12. The process of claim 2 wherein the formaldehyde scavenger is sodium bisulfite.

13. A fibrous mat produced by the process of claim 1, 2, 3, 4, 5, 6, 7, 8, 9, 10, 11 or 12.

14. A fibrous mat having fibers bonded to one another with a binder comprising a cured formaldehyde-containing resin, wherein the fibrous mat contains a formaldehyde scavenger in an amount sufficient to reduce formaldehyde emissions from the fibrous mat separate from the cured binder.

15. The fibrous mat of claim 14 wherein fibers in the mat are coated with a layer consisting essentially of a formaldehyde scavenger in an amount sufficient to reduce formaldehyde emissions from the fibrous mat.

16. The fibrous mat of claim 14 wherein the formaldehyde scavenger is selected from the group consisting of urea, low ratio melamine resins, sodium bisulfite, sodium metabisulfite, sodium sulfamate, ammonium sulfamate, an acid aniline salt, ammonium bisulfite, methane sulfonamide, succinimide, resorcinol, polyacrylamide, acrylamide, methacrylamide, melamine, diethylene triamine and its salts, triethylene tetraamine and its salts, tetraethylene pentamine and its salts, biuret, triuret, biurea, polyurea, aromatic amines, aliphatic amines, ammonia, polyamidoamines, ammonium bicarbonate, ammonium carbonate, polyethyleneamines, polyamines, dicyandiamide, a sodium salt of taurine, sulfanilic acid, sulfur compounds with valence state other than +6, ammonium sulfite, disodium salt of glutamic acid, an amino acid, a protein, an aromatic amino acid, an aminopolysaccharide, p-amino benzoic acid, thiourea, guanadine, zeolites and permanganate.

17. The fibrous mat of claim 15 wherein the formaldehyde scavenger is selected from the group consisting of urea, low ratio melamine resins, sodium bisulfite, and sodium metabisulfite.

18. The fibrous mat of claim 15 wherein the formaldehyde scavenger is sodium bisulfite.

19. The fibrous mat of claim 14 wherein the formaldehyde scavenger is present as discrete solid particles.

20. The fibrous mat of claim 19 wherein the discrete solid particles comprises a formaldehyde scavenger loaded onto an inter carrier.

21. A method of making a fibrous mat having fibers bonded to one another with a binder comprising a cured formaldehyde-containing resin wherein the fibrous mat exhibits reduced formaldehyde emissions comprising applying a formaldehyde scavenger to the fibrous mat separate from application of the binder.

22. The method of claim 21 wherein the formaldehyde scavenger is applied by spraying an aqueous mixture consisting essentially of a formaldehyde-scavenger on fibers of the fibrous mat.

23. The method of claim 22 wherein the aqueous mixture consisting essentially of the formaldehyde-scavenger is applied on to the fibers after the fibers have been treated with a formaldehyde-containing resin.

24. The method of claim 22 wherein the aqueous mixture consisting essentially of the formaldehyde-scavenger is applied on to the fibers after the fibers have been treated with a formaldehyde-containing resin, but before the resin is cured.

25. The method of claim 21 wherein the formaldehyde scavenger is selected from the group consisting of urea, low ratio melamine resins, sodium bisulfite, sodium metabisulfite, sodium sulfamate, ammonium sulfamate, an acid aniline salt, ammonium bisulfite, methane sulfonamide, succinimide, resorcinol, polyacrylamide, acrylamide, methacrylamide, melamine, diethylene triamine and its salts, triethylene tetraamine and its salts, tetraethylene pentamine and its salts, biuret, triuret, biurea, polyurea, aromatic amines, aliphatic amines, ammonia, polyamidoamines, ammonium bicarbonate, ammonium carbonate, polyethyleneamines, polyamines, dicyandiamide, a sodium salt of taurine, sulfanilic acid, sulfur compounds with valence state other than +6, ammonium sulfite, disodium salt of glutamic acid, an amino acid, a protein, an aromatic amino acid, an aminopolysaccharide, p-amino benzoic acid, thiourea, guanadine, zeolites and permanganate.

26. The method of claim 22 wherein the formaldehyde scavenger is selected from the group consisting of urea, low ratio melamine resins, sodium bisulfite, and sodium metabisulfite.

27. The method of claim 22 wherein the formaldehyde scavenger is sodium bisulfite.

28. The method of claim 21 wherein a neat form of the formaldehyde scavenger is applied to the fibrous mat.

29. The method of claim 28 wherein the neat form of the formaldehyde scavenger is in the form of solid particles.

30. The process of claim 21 wherein the scavenger is loaded onto an inert carrier.

31. A fibrous mat produced by the method of claim 21, 22, 23, 24, 25, 26, 27, 28, 29 or 30.
